(19) United States
(12) Patent Application Publication
(10) Pub. No.: US 2002/0154337 A1
(43) Pub. Date: Oct. 24, 2002

(54) Image management apparatus, image management system, control method for the apparatus and system, and program

(75) Inventor: Tsuguhide Sakata, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/119,012

(22) Filed: Apr. 10, 2002

(30) Foreign Application Priority Data
Apr. 13, 2001 (JP) 115939/2001 (PAT.

(51) Int. Cl. B41B 1/00; G06F 15/00

(52) U.S. Cl. 358/1.16; 358/1.17

(57) ABSTRACT

A data recording apparatus includes a detachable storage medium drive device for mounting a CD-R, and receives image data from a memory card inserted in a PC card slot. The data recording apparatus has a built-in storage medium in which a dedicated storage area corresponding to a storage capacity for a predetermined number of detachable storage media is formed in part of the entire storage area. Input image data is recorded in the dedicated storage area, and the image data recorded in the dedicated storage area is recorded on a CD-R.

### FIELD OF THE INVENTION

The present invention relates to an image management apparatus for managing image data, an image management system, a control method for the image management apparatus and system, and a program.

### BACKGROUND OF THE INVENTION

Conventional data recording apparatuses having an electronic photo album function take two configurations:

1. Stand-alone type (dedicated device)

2. Personal computer

As for “1. Stand-alone type”, an electronic photo album apparatus which incorporates a CD-R drive capable of writing data once has already been commercially available. This apparatus has a memory card slot. A memory card mounted in a digital camera is inserted in the memory card slot to save images recorded on the memory card in a CD-R. A series of operations use a remote controller. Various operations can be done with the remote controller on the basis of a menu on a television monitor connected to the electronic photo album apparatus.

As for “2. Personal computer”, predetermined electronic photo album software which runs on a Microsoft OS “Windows®”is activated to realize the electronic photo album function.

In this case, a digital camera is generally connected to a personal computer by using a USB interface attached to the digital camera. Alternatively, images recorded on a memory card may be sent by using the internal or external memory card slot of the personal computer. In the use of the USB interface, dedicated electronic photo album software is automatically activated when the digital camera is connected to the personal computer via a USB cable. The electronic photo album software creates an electronic photo album by moving images recorded on the memory card in the digital camera to the hard disk of the personal computer via the USB interface and recording the images on the hard disk.

The data recording apparatus having an existing electronic photo album function suffers the following problems.

In “1. Stand-alone type”, the following problems arise.

a. Image data to be saved are merely saved in a CD-R, and location information of the images are not managed. To search for a desired image, the CD-R is loaded to reproduce images, and the desired image must be searched for by its file name. After the search, the contents of the image data are displayed on a television monitor to finally check whether the image is in fact a desired one. If many recorded CD-Rs exist, they must be exchanged in search. This exchange operation continues until a desired image is found out.

b. The recording destination of image data managed as a final electronic photo album is a CD-R. Management of label information of the CD-R and the like is left to the user. The relationship between the CD-R and its recorded image data serving as its contents is represented by only a title name written on the surface of the CD-R by a pen or printer. For a large number of CD-Rs, initial identification of identifying which CD-R stores a given image is very difficult to achieve from the labels of the CD-Rs.

c. The operation means is a remote controller, and the user must manipulate it while seeing menu information on a television monitor. The user must perform many operation steps until he/she finds out a desired image, which is very cumbersome.

In “2. Personal computer”, the following problems occur.

a. Image data are recorded in a free storage area in the hard disk of a personal computer. The recording method is based on management by an image data file folder, i.e., by a general file system provided by the OS of the personal computer. Repetitive recording of a large amount of image data may unexpectedly occupy the storage area of the hard disk. This seriously influences a free space to be used for another purpose in the personal computer. In the worst case, the free space of the hard disk becomes almost full even before the user becomes aware of it. Data created by another application cannot be recorded, and a free space must be ensured by deleting data in advance.

b. As for search for image data in a hard disk, text search based on a file name or date, or visual search using a thumbnail image is available. In text search, a file is searched for, its image is displayed, and then whether the image is a desired one is checked. Many operation steps are required until search, taking a long time. In visual search, whether the current image is a desired one can be checked from a thumbnail image. However, display of the thumbnail image takes a long time, and the number of thumbnail images displayed at once depends on the monitor size or resolution. To find out a desired image, the user must cumbersomely scroll the monitor. The number of pixels of a thumbnail image on the monitor is small, and whether this image is really a desired one cannot be determined unless the entire image is displayed.

c. If image data is to be moved to a detachable data recording medium such as a CD-R in order to ensure a free space in the hard disk, the image data to be moved is determined by the operator. For many CD-Rs, the contents of a CD-R serving as an image data moving destination are not managed on the personal computer side. To find out desired image data, CD-Rs must be sequentially loaded and reproduced to search for the image data. The operator must cumbersomely exchange the CD-Rs.

d. The correspondence between a created CD-R and its contents is merely represented by a title name written on the surface of the CD-R by a pen or printer. To search for desired image data later, the user must guess the contents of a CD-R from its title name, insert the CD-R, and sequentially reproduce its image data. In other words, initial identification from the label of the CD-R is difficult to achieve.

e. The relationship between the hard disk and the CD-R is not defined. No solution is prepared for a fundamental question of whether desired image data exists in the hard disk or is moved to the CD-R.

f. The operation means are a mouse, keyboard, and the like. In text search, a search keyword must be input through the keyboard. In visual search, the operation such as scroll with the mouse is cumbersome until a desired image is found out. In other words, this operation can only be achieved by a personal computer user.

### SUMMARY OF THE INVENTION

The present invention has been made to overcome the conventional drawbacks, and has as its object to provide an image management apparatus capable of efficiently managing images, an image management system, a control method for the image management apparatus and system, and a program.

According to the present invention, the foregoing object is attained by providing an image management apparatus for managing image data, comprising;

mounting means for mounting a detachable storage medium;

input means for inputting image data from an external device;

storage means having a dedicated storage area corresponding to a storage capacity for a predetermined number of detachable storage media in part of an entire storage area;

first recording means for recording the image data input by said input means in the dedicated storage area; and

second recording means for recording the image data recorded in the dedicated storage area on the detachable storage medium.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the arrangement of a data recording apparatus according to an embodiment;

FIG. 2 is a block diagram showing the detailed arrangement of a data recording apparatus main body according to the embodiment;

FIG. 3 is a block diagram showing the detailed arrangement of a remote controller according to the embodiment;

FIG. 4 is a block diagram showing the functional arrangement of a processor for creating database management information according to the embodiment;

FIG. 5 is a view for explaining a file folder structure according to the embodiment;

FIG. 6 is a view for explaining recording of image data from a digital camera on a detachable storage medium according to the embodiment;

FIG. 7 is a view showing a printing example of a CD-R label according to the embodiment;

FIG. 8 is a flow chart for explaining recording of image data from the digital camera on the detachable storage medium according to the embodiment;

FIG. 9 is a view showing a display example of a file folder based on database management information according to the embodiment;

FIG. 10 is a view showing an example of a search index card according to the embodiment;

FIG. 11 is a view showing another example of the search index card according to the embodiment;

FIG. 12 is a view showing still another example of the search index card according to the embodiment; and

FIG. 13 is a flow chart showing search processing using the search index card according to the embodiment.

### DETAILED DESCRIPTION OF THE PREFERRED EMBODIMENT

A preferred embodiment of the present invention will be described in detail below with reference to the accompanying drawings.

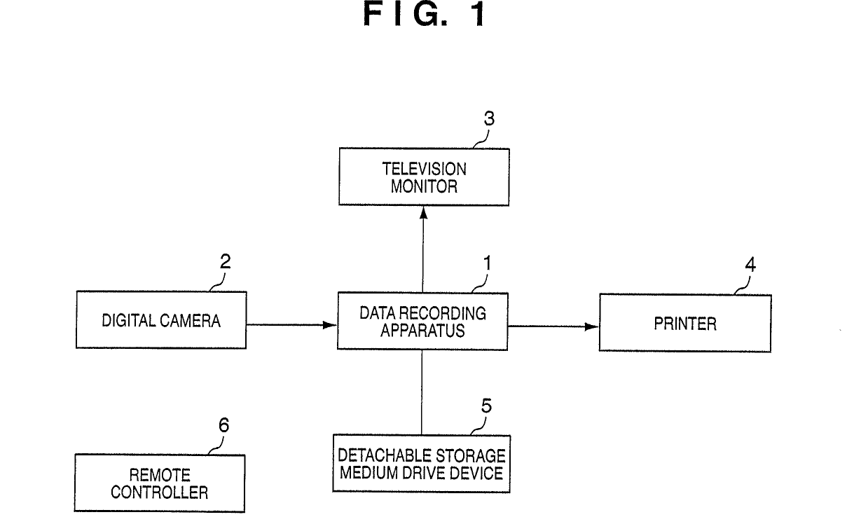

FIG. 1 is a block diagram showing the arrangement of a data recording apparatus (electronic photo album) according to the embodiment.

In FIG. 1, reference numeral 1 denotes a data recording apparatus main body; 2, a digital camera connected to the data recording apparatus main body 1 via a communication interface such as a USB interface, IEEE 1394 interface, or IrDA; 3, a television monitor used to display image data and display a graphic user interface such as an operation menu; and 4, a printer such as an inkjet printer or laser beam printer which is connected to the data recording apparatus main body 1 via, e.g., a USB interface and is used to print a label to be adhered onto a detachable storage medium to be mounted on a detachable storage medium drive device 5 or to print a search card or the like.

The external detachable storage medium drive device 5 is, e.g., a CD-R drive device. The detachable storage medium drive device 5 may be incorporated in the data recording apparatus main body 1. Reference numeral 6 denotes, e.g., a wireless infrared remote controller having an image input portion such as a barcode reader or scanner for reading code data printed on a search index card (to be described later).

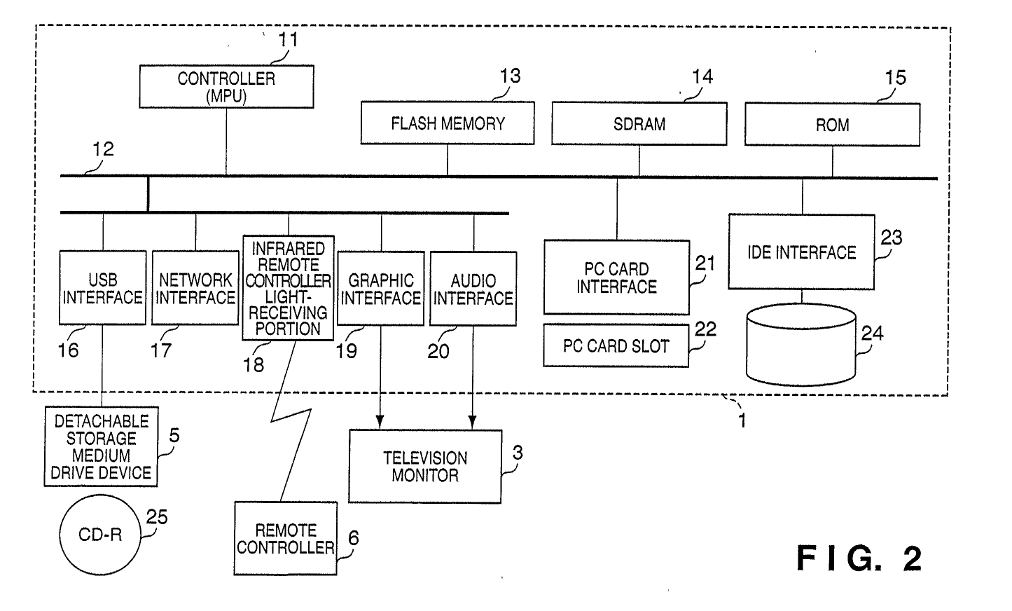

The detailed arrangement of the data recording apparatus main body 1 will be explained with reference to FIG. 2.

FIG. 2 is a block diagram showing the detailed arrangement of the data recording apparatus main body according to the embodiment.

Reference numeral 11 denotes a controller (MPU) for controlling the system. The controller 11 is connected to various building components via a data/address bus 12. Reference numeral 15 denotes a ROM for saving a program. Upon power-on, the controller 11 accesses the ROM 15 to load a boot program and saves it in an SDRAM 14. The SDRAM 14 is a high-speed memory for running a program. The SDRAM 14 is also used for temporary data storage.

Reference numeral 13 denotes a flash memory which is a rewritable memory and generally holds application software. Because of the writable configuration, programs can be easily replaced or updated by download. To the contrary, the ROM 15 stores programs, such as a boot program, which do not require any rewrite or update, in other words, programs which cannot be rewritten in terms of the system stability. A downloading program is one of these programs.

Reference numeral 16 denotes a USB interface which is connected to the digital camera 2, detachable storage medium drive device 5, printer 4, and the like; 17, a network interface used to, e.g., open access to recorded image data to a network terminal; 18, an infrared remote controller light-receiving portion which receives a remote controller signal from the remote controller 6 (to be described later); and 19, a graphic interface for displaying graphics. The controller 11 controls the graphic interface 19 to display necessary information on the television monitor 3.

Reference numeral 20 denotes an audio interface used to reproduce audio accompanying a moving picture or output an alarm sound to the operator; and 21, a PC card interface complying with the PCMCIA standard. By connecting a PC card into a PC card slot 22, image data can be received from this interface. Reference numeral 23 denotes an IDE interface which is connected to an internal storage medium having the interface, i.e., a hard disk 24.

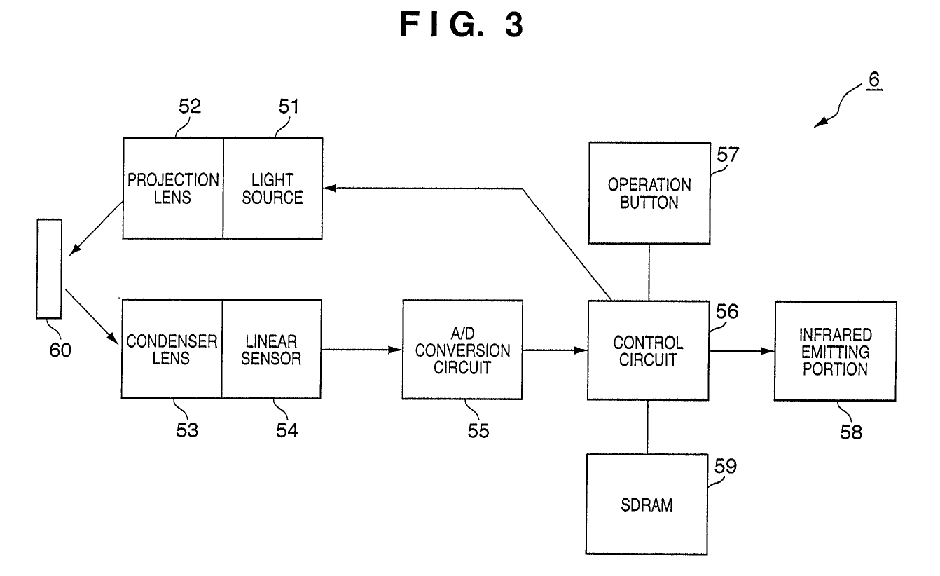

The detailed arrangement of the remote controller 6 will be described with reference to FIG. 3.

FIG. 3 is a block diagram showing the detailed arrangement of the remote controller according to the embodiment.

Reference numeral 51 denotes a code reading LED light source for a code image 60 on a search index card (to be described later) on which a two-dimensional code is printed; 52, a projection lens for projecting light from the LED light source 51 to the code image 60 on the search index card; 53, a condenser lens for condensing the light reflected by the code image 60; and 54, a linear sensor for detecting the density of the reflected light.

Reference numeral 55 denotes an A/D conversion circuit for converting an output from the linear sensor 54 into digital data; 56, a control circuit formed from a flash memory built-in microcomputer (MPU) for controlling the system; 57, various operation buttons on the remote controller 6; 58, an infrared emitting portion formed from an LED; and 59, an arithmetic SDRAM. The code image 60 is formed from, e.g., a two-dimensional code on the search card.

The operation of the remote controller 6 will be explained with reference to FIG. 3.

The operator reads the code image 60 on the search index card by using the remote controller 6. The control circuit 56 of the remote controller 6 turns on the light source 51. For example, an infrared beam is projected onto the code image 60 on the search index card via the projection lens 52. The infrared beam reflected by the code image 60 is formed into an image on the linear sensor 54 via the condenser lens 53. The linear sensor 54 outputs an analog signal of the formed image. The analog signal is converted into a digital signal by the A/D conversion circuit 55, and the digital signal is transmitted to the control circuit 56.

The control circuit 56 plane-maps the received digital signal in the arithmetic SDRAM 59. The control circuit 56 executes predetermined image processing to decode code information (e.g., PDF417) represented by the digital signal. If decoding is successful, the operator is notified of a message to this effect by, e.g., a voice. If the operator presses a predetermined operation button 57 on the basis of this notification, the control circuit 56 converts the decoded code information into a remote controller signal, and drives the infrared emitting portion 58 for controlling the remote controller. The remote controller signal is received by the controller 11 of the data recording apparatus main body 1 via the infrared remote controller light-receiving portion 18 of the data recording apparatus main body 1. The controller 11 performs the following processing on the basis of the received remote controller signal.

An example of the operation of the data recording apparatus main body 1 according to the embodiment will be explained with reference to FIG. 1.

The television monitor 3 is connected to the data recording apparatus main body 1 by using an audio/video cable. Then, the data recording apparatus main body 1 and television monitor 3 are powered on, and an initial message is displayed on the television monitor 3.

The digital camera 2 is connected to the data recording apparatus main body 1 by using a USB cable. The digital camera 2 is assumed to have recording functions in a still picture mode and 1-shot moving picture mode. The digital camera 2 is activated while being connected via the USB cable. The data recording apparatus main body 1 recognizes connection of the digital camera 2, and activates a corresponding application program by a predetermined operation. For example, the application program automatically receives image data (still picture and 1-shot moving picture) recorded on a memory card in the digital camera 2.

The data recording apparatus main body 1 sends an image transmission request command to the connected digital camera 2. In response to this request, the digital camera 2 transmits image data in the memory card to the data recording apparatus main body 1. Image data are classified into two types of pictures: still pictures and moving pictures (containing audio). These image data are sequentially transferred to the data recording apparatus main body 1 via the USB cable. The transferred image data are temporarily saved in the internal storage medium of the data recording apparatus main body 1, and undergo the following two processes.

1. Create database management information

2. Record image data from the digital camera 2 to a recording destination

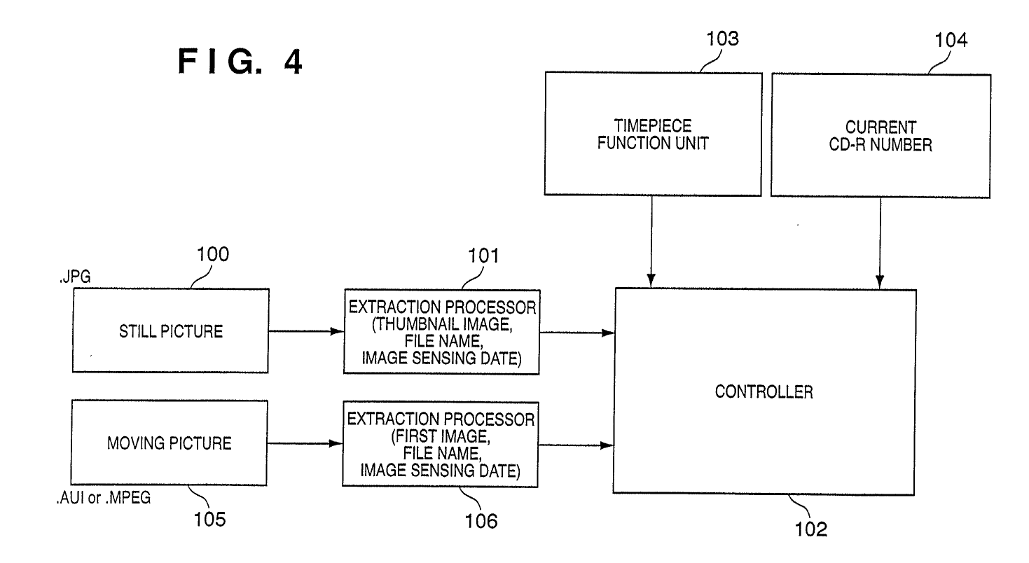

Creation of database management information will be explained with reference to FIG. 4.

FIG. 4 shows the functional arrangement of a processor for creating database management information according to the embodiment.

As shown in FIG. 4, whether image data to be processed is a still or moving picture is determined from an identifier, and corresponding processing is executed.

When image data is a still picture 100, an extraction processor 101 extracts

Thumbnail image

File name

Image capturing date data

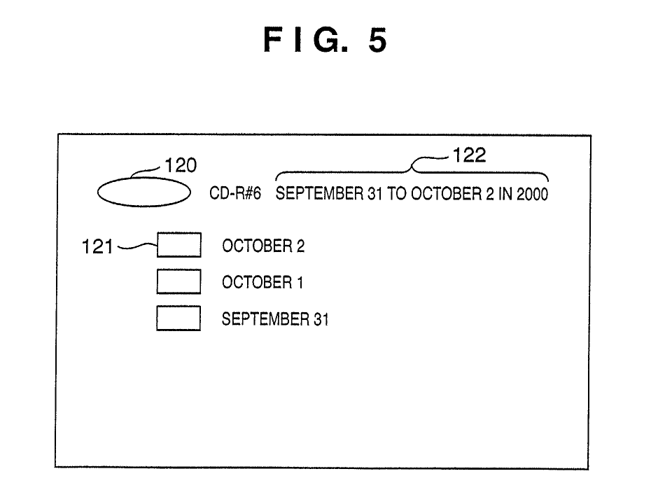

from an image file recorded by the JPEG format (.JPG). As shown in FIG. 5, a file folder 121 whose name is the date of the image capturing date data is created. Further,

Thumbnail image: file name and thumbnail image data

Supplementary information: file name, image capturing date, and loading date

are recorded below the folder.

These processes are achieved by a controller 102. Note that the controller 102 corresponds to the controller 11 in FIG. 2. At this time, the loading date is added as supplementary information. The loading date is acquired by a timepiece function unit 103 which manages the controller 102 in FIG. 4.

When image data is a moving picture 105, an extraction processor 106 extracts

Thumbnail image (first image of a moving picture

(1-shot moving picture))

File name

Image capturing date data

from an image file recorded by the AVI of MPEG format (.WAV). Similar to the still picture, a file folder whose name is the date of the image sensing date is created (if the file folder already exists, this process is skipped). Further,

Thumbnail image: file name and thumbnail image data

Supplementary information: file name, image capturing date, and loading date

are recorded below the folder.

These processes are done by the controller 102. At this time, the loading date is added as supplementary information, similar to the still picture.

The file folder which uses the date as a created folder name belongs to the management area of a storage area managed for each detachable storage medium, as shown in FIG. 5. More specifically, in FIG. 5, reference numeral 120 denotes a current storage area when the detachable storage medium is a CD-R. The current storage area 120 indicates CD-R #6 representing the identification number of the CD-R, i.e., the sixth CD-R. The file folder whose folder name is the image capturing date is created in the storage area of CD-R #6. The storage area called the management area serves as the upper file folder of the file folder whose file name is the date. Reference numeral 122 denotes CD-R supplementary information which is service information representing the period between the dates of the folder names of file folders contained in the management area.

After a file folder serving as the recording destination of image data is determined in this manner, the controller 102 in FIG. 4 records the image data from the digital camera 2 on the corresponding file folder having the date name.

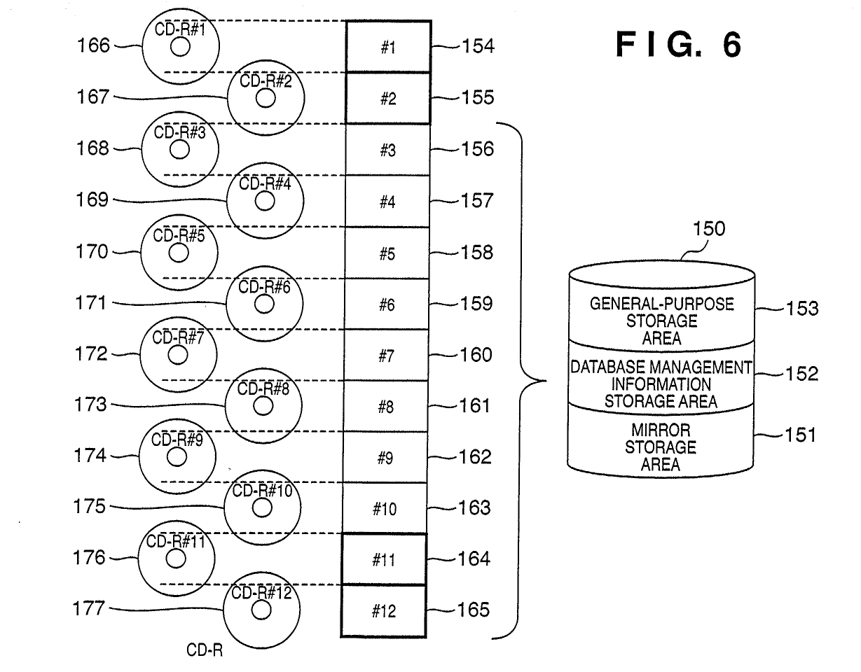

Recording of image data from the digital camera 2 on a detachable storage medium will be explained with reference to FIG. 6.

FIG. 6 is a view for explaining recording of image data from the digital camera on a detachable storage medium according to the embodiment.

In FIG. 6, reference numeral 150 denotes a built-in storage portion incorporated in the data recording apparatus main body 1. The built-in storage unit 150 corresponds to the hard disk 24 in FIG. 2. The built-in storage unit 150 will be exemplified as a hard disk having a storage capacity of 30 GB.

The storage area of the built-in storage medium 150 is segmented into

1. Mirror storage area 151 for a detachable storage medium

2. Database management information storage area 152

3. Another general-purpose storage area 153

These storage areas 151 to 153 may be formed from separate hard disks. In this embodiment, the storage areas 151 to 153 are assumed to be formed in the single hard disk 24.

An example of the detachable storage medium is a CD-R, which generally has a storage capacity of 650 MB. A mirror storage area corresponding to 10 CD-Rs is formed as the mirror storage area 151. Accordingly, the mirror storage area has a storage capacity of 6.5 GB.

The 6.5-GB mirror storage area 151 is segmented into 10 650-MB segmented-mirror storage areas each corresponding to one CD-R. Each segmented-mirror storage area is assigned a corresponding CD-R identification number #n (n: natural number).

The mirror storage area 151 corresponds to 10 CD-Rs, and if 12 CD-Rs to be processed exist, as shown in FIG. 6, data are newly recorded by deleting contents stored in two CD-Rs, e.g., segmented-mirror storage areas 154 and 155 whose content recording times are old. In the example of FIG. 6, the contents of CD-Rs 168 to 177 are stored in corresponding segmented-mirror storage areas while segmented-mirror storage areas 156 to 165 assigned identification numbers #3 to #12 exist.

To record image data from the digital camera 2 on the data recording apparatus main body 1, a file folder whose folder name is the image sensing date is created in the segmented-mirror storage area 154 corresponding to CD-R #1 on the built-in storage medium. That is, a file folder is created in the segmented-mirror storage area 154 corresponding to the CD-R 166 of the mirror storage area 151, and image data is recorded in this file folder.

At the same time, database management information corresponding to this image data is created and stored in the database management information storage area 152. In this database management information storage area 152, a thumbnail image containing the above-described supplementary information is recorded below the file folder whose folder name is the date. This file folder belongs to the management area of corresponding CD-R #1.

Recording of image data from the digital camera 2 is repeated. If the recording amount in the segmented-mirror storage area 154 reaches the 650-MB storage capacity, the controller 102 notifies the operator that the contents of the segmented-mirror storage area 154 are to be recorded in the corresponding CD-R 166. Image data in the segmented-mirror storage area 154 are recorded on the CD-R 166.

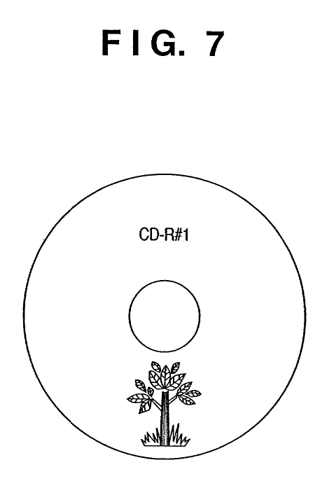

After recording on the CD-R 166, the controller 102 simultaneously notifies the operator that a CD-R label is to be printed. The CD-R label is printed by the printer 4. A CD-R identification number is printed on the CD-R label, as shown in FIG. 7. In addition, some of the title, date, and recorded image data may be printed.

Recording of image data from the digital camera 2 on the segmented-mirror storage area and corresponding CD-R continues. If the CD-R to be recorded reaches the CD-R 175, the segmented-mirror storage area reaches the corresponding segmented-mirror storage area 163, and the recording amount in the mirror storage area 151 reaches its storage capacity, the segmented-mirror storage area 154 whose image data recording time is the oldest is used as the segmented-mirror storage area 164 corresponding to the next CD-R 176. Target image data are recorded in the segmented-mirror storage area 154. That is, all the image data in the segmented-mirror storage area 154 are erased, and then target image data are recorded. The image data recorded in the segmented-mirror storage area 154 are recorded on the CD-R 176 in the above-described fashion. As for the CD-R 177, the segmented-mirror storage area 155 is used as the segmented-mirror storage area 165.

Accordingly, segmented-mirror storage areas corresponding to 10 CD-Rs are always ensured in the built-in storage medium 150.

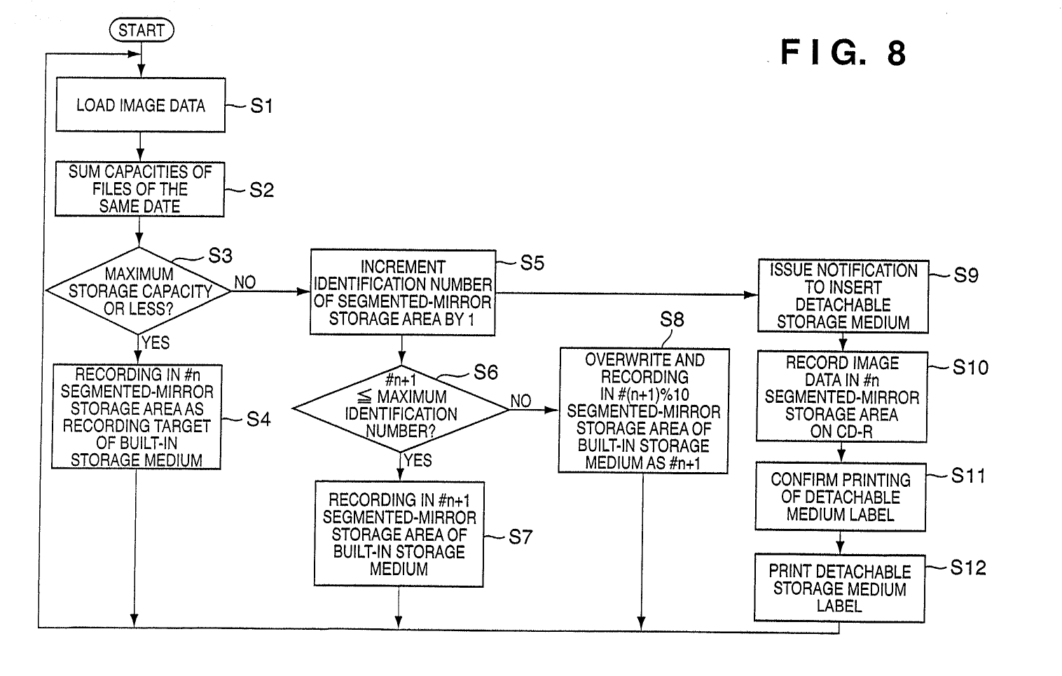

Processing executed by the controller 11 will be described with reference to FIG. 8.

FIG. 8 is a flow chart showing processing executed by the controller according to the embodiment.

In step S1, image data from the digital camera 2 is received by the data recording apparatus main body 1. The received image data is temporarily stored in a primary memory area managed by the controller 11. In step S2, the received image data is held in the SDRAM 14. The file size and date information of the image data are extracted from the supplementary information, and the capacity of the image data to be processed is calculated.

In step S3, whether the total capacity of the recorded file capacity and the image data capacity calculated in step S2 is the maximum storage capacity (650 MB) of the segmented-mirror storage area or less is checked. The maximum storage capacity is one when a storage medium corresponding to the segmented-mirror storage area is a CD-R. If the storage medium is a DVD-RAM or an expanded-capacity CD-R (750 MB version), the corresponding maximum storage capacity is used.

If the total capacity is the maximum storage capacity or less (YES in step S3), the flow shifts to step S4, and the image data is recorded in a segmented-mirror storage area having an identification number #n (current segmented-mirror storage area) within the mirror storage area 151 on the built-in storage medium 150. If NO in step S3, the identification number #n of the segmented-mirror storage area to be processed is incremented by 1 to #n+1 in step S5.

In step S6, whether the identification number #n+1 is equal to or smaller than the maximum identification number of the segmented-mirror storage area is checked. In this embodiment, the maximum identification number is 10. If the identification number #n+1 is not the maximum identification number (YES in step S6), the flow advances to step S7, and image data is recorded in a segmented-mirror storage area having an identification number #n+1. At this time, a file folder whose name is a date is created, and the image data is recorded in this file folder. If NO in step S6, the flow shifts to step S8, and all the image data in a segmented-mirror storage area having an identification number indicated by the remainder of (n+1)%10, i.e., division of the identification number #n+1 by 10 are deleted. After that, image data is recorded. For example, for an identification number #n+1 =11, 11%10 =1. All the image data in the segmented-mirror storage area having the identification number #1 are deleted, and image data is newly recorded.

The controller 11 executes processing in step S9 after step 5. More specifically, if the total capacity exceeds the maximum storage capacity, image data up to immediately received data are recorded on a CD-R. In step S9, the controller 11 issues a notification which prompts the operator to insert an empty CD-R into the data recording apparatus main body 1. After insertion is confirmed, the controller 11 records, on the CD-R, image data stored in a segmented-mirror storage area having an identification number #n on the built-in storage medium 150. This CD-R is assigned the identification number #n. In step S11, the controller 11 notifies the operator that a CD-R label is to be printed. After the presence of a CD-R label in the printer 4 is confirmed, the controller 11 prints the CD-R label containing the identification number #n in step S12.

In this way, image data in the digital camera 2 are recorded in the mirror storage area 151 of the built-in storage medium 150. Database management information for the image data is recorded in the database management information storage area 152. The data recording apparatus main body 1 can construct an image database which realizes image data search utilizing the database management information.

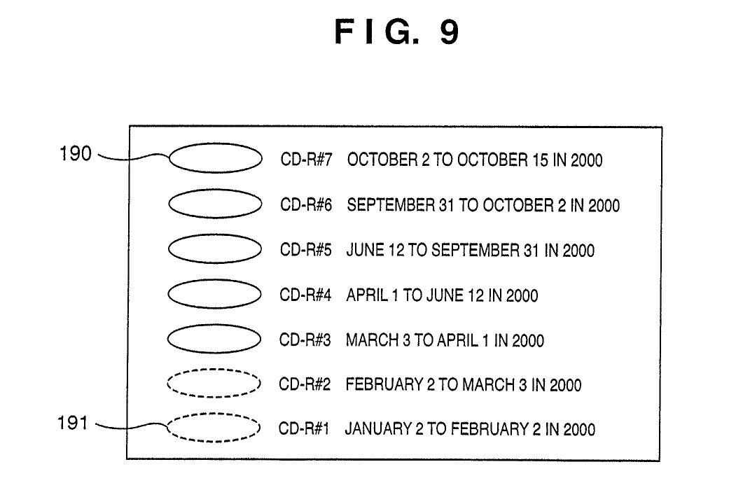

Processing when image data recorded and managed by the data recording apparatus main body 1 is to be searched for will be explained with reference to FIG. 9.

FIG. 9 shows a display example of a file folder based on database management information stored in the database management information storage area 152 of the built-in storage medium 150 by operating the data recording apparatus main body 1 by the operator.

In FIG. 9, reference numeral 190 denotes an icon visually representing the presence of a segmented-mirror storage area corresponding to an image data-recorded CD-R on the built-in storage medium 150; and 191, an icon visually representing the absence of a segmented-mirror storage area corresponding to an image data-recorded CD-R on the built-in storage medium 150. In this case, to refer to image data to be searched for, a corresponding CD-R is inserted into the data recording apparatus main body 1 to refer to the image data in the CD-R because the segmented-mirror storage area in which the image data is stored does not exist in the built-in storage medium 150. Even in this case, the database management information (thumbnail image containing supplementary information) exists in the database management information storage area. The thumbnail image containing the supplementary information can be referred to without inserting the corresponding CD-R into the data recording apparatus main body 1.

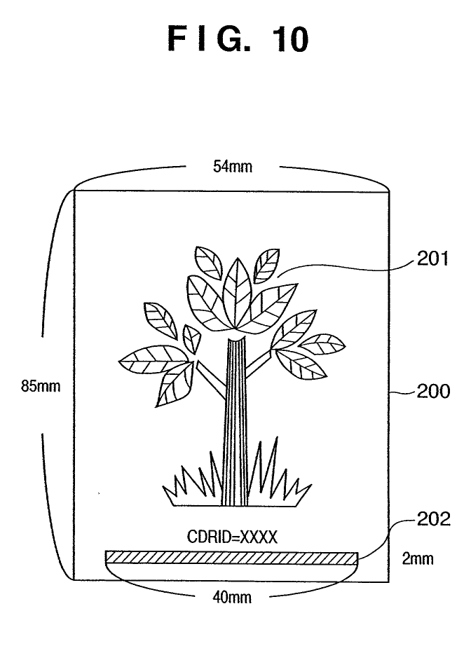

To search image data stored in the data recording apparatus main body 1 for desired image data, a search index card as shown in FIG. 10 is created. The remote controller 6 is manipulated to search the image data stored in the data recording apparatus main body 1 for the desired image data.

First, a search index card as shown in FIG. 10 is created using the printer 4. The size of the search index card can be a credit card size which can be easily stocked. Necessary items of print information on the search index card are

1. Thumbnail image

2. Recording destination information (CD-R identification number, loading date, and file name)

In FIG. 10, reference numeral 201 denotes a printed image of the thumbnail image of, e.g., a still picture; and 202, a code image prepared by encoding recording destination information as a coded data and printing the coded data. The encoding method uses a two-dimensional code called PDF417. PDF417 is a known encoding scheme, and its description will be omitted. Printing such a code image at 300 DPI enables recording of about 8 bytes in 1 mm². For a search index card size of 54 mm×85 mm, a printing region capable of printing a 40 mm×2 mm code image can be easily ensured, and 640-byte text data can be recorded. This data contains recording destination information.

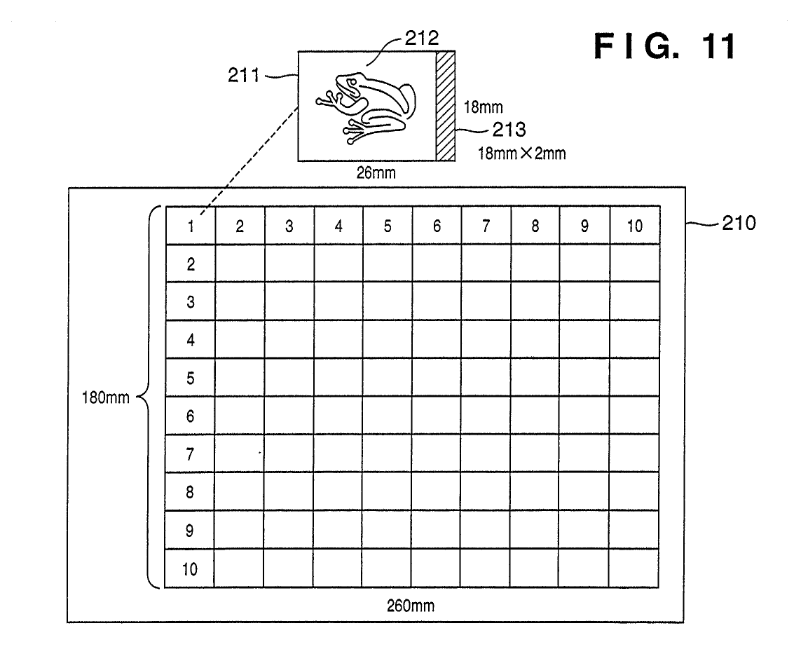

Other than the search index card shown in FIG. 10, a search index card 210 as shown in FIG. 11 is created. This permits searching image data stored in the data recording apparatus main body 1 for desired image data.

In FIG. 11, a 260 mm×180 mm printing region except for a margin is set on an A4-size sheet (210 mm×297 mm) as the search index card 210. A 26 mm×18 mm image 211 is printed in this printing region. With this setting, a total of 10×10=100 images can be printed on one search index card 210. An image 211 has a thumbnail image 212 and a 18 mm×2 mm code image 213. Text data of about 256 bytes can be recorded on the code image 213.

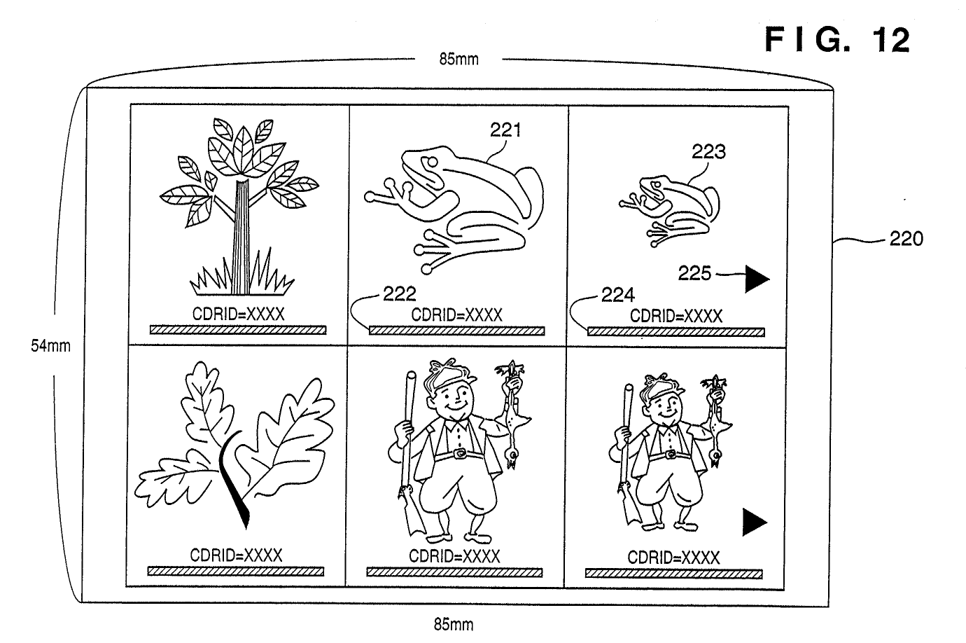

As another search index card, a search index card 220 as shown in FIG. 12 is created. This also allows searching image data stored in the data recording apparatus main body 1 for desired image data.

In FIG. 12, the search index card 220 is formed from six images printed on a card-size sheet. Reference numeral 225 denotes an icon representing that image data is a moving picture; 221 and 223, images; and 222 and 224, code images.

Creation of each search index card described above starts when the operator inputs an instruction to the data recording apparatus main body 1 or when the data recording apparatus main body 1 notifies the operator of creation in recording image data on a CD-R. After the data recording apparatus main body 1 enters the search index card creation mode, the controller 11 accesses the predetermined database management information storage area 152 on the built-in storage medium 150, and acquires a target thumbnail image containing supplementary information. The controller 11 generates printing data in accordance with a predetermined printing method, and prints the acquired thumbnail image containing supplementary information by the printer 4. If the image data is a moving picture, a moving picture mark is added. Whether image data is a moving picture is determined by the extension of the file name.

Each search index card described above is merely an example, and can be appropriately changed and designed in accordance with the operator's purpose.

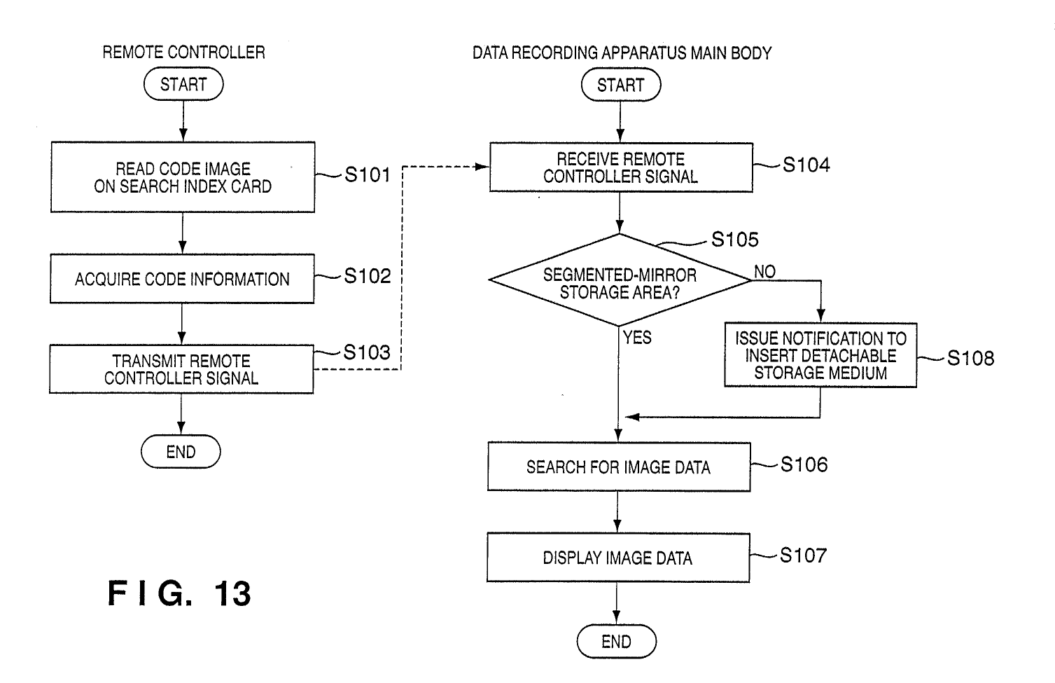

Processing when image data stored in the data recording apparatus main body 1 are searched for desired image data by using a prepared search index card will be described with reference to FIG. 13.

FIG. 13 is a flow chart showing search processing using a search index card according to the embodiment.

In step S101, a code image on a search index card is read using the remote controller 6. After analysis of code information obtained by reading the code image is completed in step S102, the operator is notified of a message to that effect by, e.g., a voice. In step S103, if the operator manipulates a predetermined operation button 57 on the remote controller 6, the control circuit 56 converts the signal into a remote controller signal corresponding to the code information, and transmits the remote controller signal to the data recording apparatus main body 1.

In step S104, the data recording apparatus main body 1 acquires the identification number of a CD-R corresponding to recording destination information contained in the received remote controller signal. In step S105, whether the acquired identification number exists in the database management information storage area 152 is confirmed. The presence/absence of a segmented-mirror storage area corresponding to the CD-R having this identification number is determined based on the confirmation result. If no segmented-mirror storage area exists (NO in step S105), the flow advances to step S108, and a notification which prompts the operator to insert a CD-R having the corresponding identification number is issued. After insertion of the CD-R is confirmed, the flow shifts to step S106. If the segmented-mirror storage area exists (YES in step S105), the flow shifts to step S106, and the controller 11 searches the segmented-mirror storage area for the target image data on the basis of the loading date and file name contained in the remote controller signal. If a CD-R is inserted, the controller 11 searches the CD-R for the target image data.

In step S107, if the searched image data is a still picture in the JPEG format, the image data is JPEG-decompressed and displayed on the television monitor 3 while the graphic interface 19 is controlled. If the searched image data is a moving picture in the AVI or MPEG format, the image data is reproduced and displayed on the television monitor 3 while the graphic interface 19 is controlled.

In the data recording apparatus main body 1, database management information plays an important role as a building component which realizes the present invention. This database management information must be prevented from being lost owing to a fault of the built-in storage medium 150 which stores it. For this purpose, the data recording apparatus main body 1 may be equipped with, as one function, a utility program which periodically backs up in an external detachable storage medium (CD-R) the database management information storage area 152 which stores database management information on the built-in storage medium 150.

The built-in storage medium 150 has been described as a hard disk, but may be another storage medium having a large storage capacity such as a flash memory. The detachable storage medium has been described as a CD-R, but may be a CD-RW, DVD-RAM, MO, removable hard disk, or microdrive. Further, the detachable storage medium may be any combination of these mediums.

In the above description, a recorded CD-R is assumed to be stocked on the operator's own responsibility. Alternatively, a drive device such as a CD-R changer capable of storing a plurality of CD-Rs may be connected to the data recording apparatus main body 1 and managed.

As described above, this embodiment manages database management information about information of detachable storage media serving as recording destinations for image data of the digital camera 2. The embodiment collectively records and manages the recording destinations of all image data recorded by the data recording apparatus main body 1. The use of this database management information facilitates search of image data managed by the data recording apparatus main body 1.

The thumbnail image of image data is formed as database management information. A search index card on which the thumbnail image is printed can be created. By referring to the search index card, initial selection of image data to be searched for can be easily achieved without using the data recording apparatus main body 1.

The recording capacity of a detachable storage medium is adopted as a unit, and a plurality of mirror storage areas are defined in a predetermined storage area on the built-in storage medium of the data recording apparatus main body 1. In addition, data are deleted from older ones to write new data in the recording capacity unit of the detachable storage medium so as not to exceed the mirror storage capacity. In recording image data in the built-in storage medium, erroneous occupation of the entire storage capacity can be avoided. The storage area of the built-in storage medium can be effectively used.

The identification number of a detachable storage medium that is managed by database management information is printed on a label for the detachable storage medium. When a detachable storage medium serving as the recording destination of image data to be searched for must be inserted into the data recording apparatus main body 1 in order to search for the image data in the data recording apparatus main body 1, the identification number of a detachable storage medium is presented to the operator, and the operator can easily choose a detachable storage medium to be inserted.

Recording destination information of image data to be searched for is recorded as a code image on a search index card. This code image is read by the remote controller 6 capable of reading the code image, and recording destination information obtained from this code image is transmitted to the data recording apparatus main body 1. With only this operation, desired image data can be searched for.

The present invention may be applied to a system constituted by a plurality of devices (e.g., a host computer, interface device, reader, and printer) or an apparatus (e.g., a copying machine or facsimile apparatus) comprising a single device.

The object of the present invention is also achieved when a storage medium which stores software program codes for realizing the functions of the above-described embodiment is supplied to a system or apparatus and the computer (or the CPU or MPU) of the system or apparatus reads out and executes the program codes stored in the storage medium.

In this case, the program codes read out from the storage medium realize the functions of the above-described embodiment, and the storage medium which stores the program codes constitutes the present invention.

The storage medium for supplying the program codes includes a floppy disk, hard disk, optical disk, magnetooptical disk, CD-ROM, CD-R/RW, DVD-ROM/RAM, magnetic tape, nonvolatile memory card, and ROM.

The functions of the above-described embodiment are realized when the computer executes the readout program codes. Also, the functions of the above-described embodiment are realized when an OS (Operating System) running on the computer performs part or all of actual processing on the basis of the instructions of the program codes.

The functions of the above-described embodiment are also realized when the program codes read out from the storage medium are written in the memory of a function expansion board inserted into the computer or the memory of a function expansion unit connected to the computer, and the CPU of the function expansion board or function expansion unit performs part or all of actual processing on the basis of the instructions of the program codes.

When the present invention is applied to the storage medium, the storage medium stores program codes corresponding to the above-described flow charts.

As many apparently widely different embodiments of the present invention can be made without departing from the spirit and scope thereof, it is to be understood that the invention is not limited to the specific embodiments thereof except as defined in the appended claims.

What is claimed is:

1. An image management apparatus for managing image data, comprising:
mounting means for mounting a detachable storage medium;
input means for inputting image data from an external device;
storage means having a dedicated storage area corresponding to a storage capacity for a predetermined number of detachable storage media in part of an entire storage area;
first recording means for recording the image data input by said input means in the dedicated storage area; and
second recording means for recording the image data recorded in the dedicated storage area on the detachable storage medium.

2. The apparatus according to claim 1, wherein the dedicated storage area includes a plurality of dedicated storage areas segmented by the predetermined number.

3. The apparatus according to claim 2, wherein said first recording means sequentially records the image data input by said input means in the plurality of segmented dedicated storage areas, and when recording of target image data becomes impossible, deletes all image data from a segmented dedicated storage area whose recording time is the oldest, and newly writes image data to be recorded.

4. The apparatus according to claim 1, wherein said storage means further comprises a management area for storing management information which is used for recording of said second recording means and contains an identification number unique to a detachable storage medium, and
the apparatus further comprises printing means for printing the management information corresponding to the detachable storage medium on which image data is recorded by said second recording means.

5. The apparatus according to claim 4, wherein each segmented dedicated storage area is assigned the identification number of the detachable storage medium on which the image data recorded in the segmented dedicated storage area is recorded by said second recording means.

6. The apparatus according to claim 5, further comprising:
reception means for receiving an image data search request signal;
determination means for referring to the management information and determining whether image data represented by the search request signal is recorded in the segmented dedicated storage area; and
output means for, when the image data represented by the search request signal is recorded in the segmented dedicated storage area as a result of determination of said determination means, outputting the image data, and when the image data represented by the search request signal is not recorded in the segmented dedicated storage area, outputting an identification number of a detachable storage medium on which the image data represented by the search request signal is recorded.

7. The apparatus according to claim 4, wherein the management information further contains recording destination information representing a recording location of image data recorded on the detachable storage medium by said second recording means, and thumbnail image data of the image data, and
said printing means prints, on a recording medium, the thumbnail image data and a code image obtained by further encoding the recording destination information contained in the management information.

8. The apparatus according to claim 6, wherein the apparatus further comprises operation means capable of reading a code image on a recording medium, and
said operation means generates the search request signal on the basis of the code image and transmits the search request signal to said reception means.

9. An image management system having an operation unit and an image management apparatus for managing image data, comprising:
said image management apparatus comprises
mounting means for mounting a detachable storage medium,
input means for inputting image data from an external device,
storage means having a dedicated storage area corresponding to a storage capacity for a predetermined number of detachable storage media in part of an entire storage area,
first recording means for recording the image data input by said input means in the dedicated storage area,
second recording means for recording the image data recorded in the dedicated storage area on the detachable storage medium, and
reception means for receiving an image data search request signal from said operation unit, and
said operation unit comprises
reading means for reading a code image obtained by encoding recording destination information of image data which is recorded on a recording medium and is to be searched for, and
transmission means for generating a search request signal based on the code image read by said reading means and transmitting the search request signal to said image management apparatus.

10. The system according to claim 9, wherein the dedicated storage area includes a plurality of dedicated storage areas segmented by the predetermined number.

11. The system according to claim 10, wherein said first recording means sequentially records the image data input by said input means in the plurality of segmented dedicated storage areas, and when recording of target image data becomes impossible, deletes all image data from a segmented dedicated storage area whose recording time is the oldest, and newly writes image data to be recorded.

12. The system according to claim 9, wherein said storage means further comprises a management area for storing management information which is used for recording of said second recording means and contains an identification number unique to a detachable storage medium, and
the system further comprises printing means for printing the management information corresponding to the detachable storage medium on which image data is recorded by said second recording means.

13. The system according to claim 12, wherein each segmented dedicated storage area is assigned the identification number of the detachable storage medium on which the image data recorded in the segmented dedicated storage area is recorded by said second recording means.

14. The system according to claim 13, wherein said image management apparatus further comprises
determination means for referring to the management information and determining whether image data represented by the search request signal received by said reception means is recorded in the segmented dedicated storage area, and
output means for, when the image data represented by the search request signal is recorded in the segmented dedicated storage area as a result of determination of said determination means, outputting the image data, and when the image data represented by the search request signal is not recorded in the segmented dedicated storage area, outputting an identification number of a detachable storage medium on which the image data represented by the search request signal is recorded.

15. The system according to claim 12, wherein the management information further contains recording destination information representing a recording location of image data recorded on the detachable storage medium by said second recording means, and thumbnail image data of the image data, and
said printing means prints, on a recording medium, the thumbnail image data and a code image obtained by further encoding the recording destination information contained in the management information.

16. A method of controlling an image management apparatus which has a mounting portion capable of mounting a detachable storage medium and manages image data, comprising:
an input step of inputting image data;
a first recording step of recording the image data input in the input step in a dedicated storage area which is formed in part of an entire storage area of a built-in storage medium mounted in the image management apparatus and corresponds to a storage capacity for a predetermined number of detachable storage media; and
a second recording step of recording the image data recorded in the dedicated storage area on the detachable storage medium.

17. A method of controlling an image management system having an operation unit and an image management apparatus which has a mounting portion capable of mounting a detachable storage medium and manages image data, comprising:
an input step of inputting image data;
a first recording step of recording the image data input in the input step in a dedicated storage area which is formed in part of an entire storage area of a built-in storage medium mounted in the image management apparatus and corresponds to a storage capacity for a predetermined number of detachable storage media;
a second recording step of recording the image data recorded in the dedicated storage area on the detachable storage medium; and
a reception step of receiving an image data search request signal which is generated by the operation unit on the basis of a code image obtained by encoding recording destination information of image data which is recorded on a recording medium and is to be searched for.

18. A program for causing a computer to control an image management apparatus which has a mounting portion capable of mounting a detachable storage medium and manages image data, comprising:
a program code of an input step of inputting image data;
a program code of a first recording step of recording the image data input in the input step in a dedicated storage area which is formed in part of an entire storage area of a built-in storage medium mounted in the image management apparatus and corresponds to a storage capacity for a predetermined number of detachable storage media; and
a program code of a second recording step of recording the image data recorded in the dedicated storage area on the detachable storage medium.

19. A program for causing a computer to control an image management system having an operation unit and an image management apparatus which has a mounting portion capable of mounting a detachable storage medium and manages image data, comprising:
a program code of an input step of inputting image data;
a program code of a first recording step of recording the image data input in the input step in a dedicated storage area which is formed in part of an entire storage area of a built-in storage medium mounted in the image management apparatus and corresponds to a storage capacity for a predetermined number of detachable storage media;
a program code of a second recording step of recording the image data recorded in the dedicated storage area on the detachable storage medium; and
a program code of a reception step of receiving an image data search request signal which is generated by the operation unit on the basis of a code image obtained by encoding recording destination information of image data which is recorded on a recording medium and is to be searched for.
